(19) United States
(12) Patent Application Publication
(10) Pub. No.: US 2011/0005188 A1
(43) Pub. Date: Jan. 13, 2011

(54) AIR INTAKE LIP FOR TURBOJET NACELLE

(75) Inventor: Christian Roger, Sainte (FR)

Correspondence Address: CANTOR COLBURN LLP, 20 Church Street, 22nd Floor, Hartford, CT, 06103, US

(73) Assignee: AIRCELLE, Gonfreville L'orcher (FR)

(21) Appl. No.: 12/921,949

(22) PCT Filed: Mar. 12, 2009
(86) PCT No.: PCT/FR09/50412

§ 371 Date: Sep. 27, 2010

(30) Foreign Application Priority Data
Mar. 14, 2008 (FR) 08/01413

(51) Int. Cl. F02G 3/00

(52) U.S. Cl. 60/39.093

(57) ABSTRACT

The invention relates to a lip that includes, on the inner surface thereof, an electric de-icing device (11) comprising at least one panel including a cellular structure (13), made of electrically conductive material, and an electrical connection means connected to the cellular structure.

### TECHNICAL FIELD

This invention relates to an air intake lip for turbojet nacelle.

### BACKGROUND

An airplane is powered by one or more propulsive systems including a turbojet, housed in a tubular nacelle. Each propulsive system is attached to the airplane by an engine strut, generally located under a wing or at the fuselage.

A nacelle generally has a structure including an air intake upstream of the turbojet, a central section for surrounding a turbojet fan, a downstream section housing thrust reverser means designed for surrounding the combustion chamber of the turbojet, and is generally completed by an exhaust nozzle whereof the output is located downstream of the turbojet.

The air intake includes, on the one hand, an air intake lip adapted to allow optimal uptake of air into the turbojet for supplying the fan and the internal compressors of the turbojet, and on the other hand, a downstream structure on which the lip is mounted and designed for conveniently channelling the air towards the blades of the fan. The system is attached upstream of a fan casing belonging to the upstream section of the nacelle.

In flight, depending on the temperature and humidity conditions, ice may form on the nacelle at the air intake lip. The presence of frost or ice modifies the aerodynamic properties of the air intake and disrupts the streaming of air towards the fan. In addition, pieces of ice may eventually break away from the air intake lip and collide with turbojet components such as the fan blades.

Since the performance of the turbojet is linked to the quantity and quality of the uptake of air achieved by the air intake, it is convenient to de-ice the air intake lip when ice or frost is formed thereon.

A first solution for de-icing an air intake lip is described in U.S. Pat. No. 4,688,757. This solution consists in drawing hot air at the turbojet compressor and conveying it to the air intake lip, thereby heating the walls by flowing through an inner channel of the air intake lip. However, such a device requires a duct system for conveying hot air between the turbojet and the air intake, and an exhaust system for the hot air at the air intake lip. This increases the mass of the propulsive system, which is not desired.

Moreover, such a system causes a loss of performance of the turbojet by drawing a quantity of air therefrom.

In addition, the temperature of the hot air drawn into the turbojet generally being around 400° C., the metal parts of the nacelle are subjected, at the air intake, to a steep temperature gradient generating significant thermal stresses in these metal parts.

An additional consequence of such a system is that in order to avoid multiple hot air intakes and outlets, the air intake lip is made in a single piece, which must be completely changed should its external profile be altered, due for instance to an impact with external elements such gravel, birds, hail and others.

A second solution, described in patent EP 1 495 963, is to apply a heating resistance on an outer wall of the air intake lip supplied electrically from an electric power source of the nacelle. This technology makes it possible to achieve a modular air intake lip from several basic structures.

However, the heating resistance is subject to many impacts that can cause premature wear, and even the malfunction, thereof.

Such a malfunction of the heating resistance may cause an accumulation of ice or frost on the air intake and therefore a decrease in the performance of the turbojet.

### BRIEF SUMMARY

The purpose of this invention is to overcome part or all the drawbacks mentioned previously.

The invention provides an air intake lip of a turbojet nacelle including a de-icing device, which is a simple, reliable and lightweight structure.

To this end, this invention relates to an air entry lip of a turbojet nacelle, characterised in that it includes, on the inner surface thereof, an electric de-icing device including at least one panel comprising an electrically conductive cellular structure material and electrical connection means connected to the cellular structure.

When the electrical connection means are connected to a power supply, a heating resistance is formed by the cellular structure of the panel, thus providing the de-icing of a surface to be de-iced, located close the de-icing device.

Implementation of the de-icing device from a panel including a cellular structure provides a significant heating surface and therefore lowers the temperature necessary for de-icing the same surface to be de-iced, resulting in increased energy and reliability.

It must be observed that the cellular structure forms a sound attenuation structure.

Thus, a fundamental advantage of the de-icing device resides in the fact that it fulfils both a de-icing function and an acoustic attenuation function.

Consequently, the de-icing device according to the invention can be used to replace the sound attenuation structures generally arranged in an air intake of a turbojet nacelle.

Use of such a de-icing device does not require additional heating elements, resulting in an improved mass.

In addition, when the de-icing device according to the invention is used as a sound attenuation structure in an air intake, it is located inside the air intake and thus protected against external aggressions.

Preferably, the cells of the cellular structure extend substantially perpendicularly to the panel plane.

Advantageously, the cellular structure is made from a system of adjacent strips extending in a generally common direction, two adjacent strips being alternately in contact with each other and away from each other so as to form cells.

According to one embodiment of the invention, the panel comprises first and second electrical connection means, the first end of each strip being connected to the first electrical connection means and the second end of each strip being connected to the second electrical connection means.

According to a first embodiment of the invention, the strips are fixed to each other by adhesive layers arranged in the contact areas among the latter, the adhesive for gluing the strips among the latter preferably being electrically insulating.

According to a second embodiment of the invention, the strips are attached to each other by welding at the contact areas among the latter.

Advantageously, the panel includes electrically insulating first and second sheets covering the cellular structure so as to seal the cells of the cellular structure.

Preferably, the panel comprises electrically insulating elements covering the edges of the cellular structure.

### BRIEF DESCRIPTION OF THE DRAWINGS

In any case, the invention will be better understood with the help of the following description with reference to the annexed diagrammatic drawing showing, as a non-exhaustive example, an embodiment of this lip and of this de-icing device.

FIG. 1 shows a diagrammatic perspective view of a turbojet nacelle.

FIG. 2 is an enlarged cross-sectional view of a structure of an air intake lip including a de-icing device according to the invention.

FIG. 3 is a perspective view of the de-icing device of FIG. 2.

FIGS. 4 and 5 are perspective views of two embodiments for fixing the strips forming the cellular structure of the de-icing device.

FIGS. 6 and 7 show two embodiments of the de-icing device according to the invention.

### DETAILED DESCRIPTION

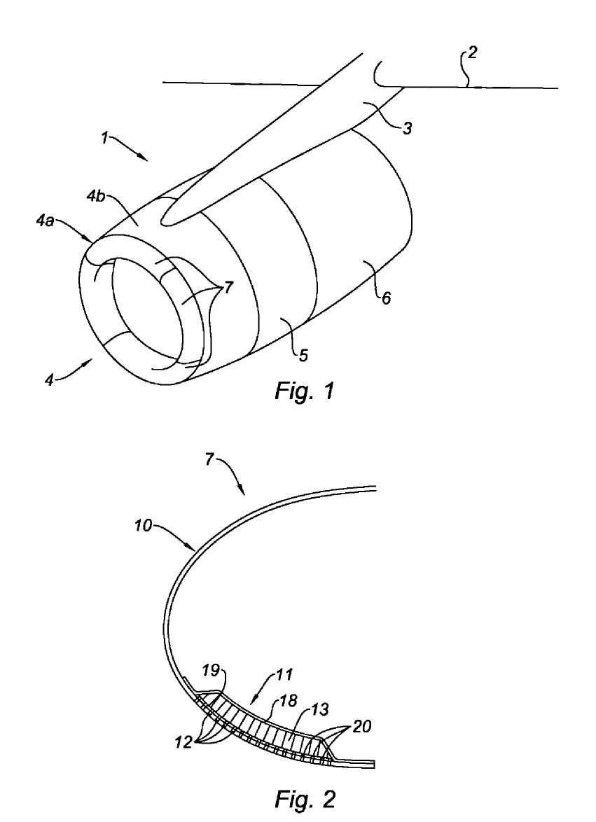

A nacelle 1 according to the invention as shown in FIG. 1 constitutes a tubular housing for a turbojet (not shown) for which it serves to channel the airflow generated thereby. The nacelle 1 is located under a wing 2 on which it is attached by an engine strut 3. It also houses various components necessary for the operation of the turbojet.

More specifically, the nacelle 1 has a structure including a front section forming an air intake 4, a central section 5 surrounding a fan (not shown) of the turbojet, and a rear section 6 surrounding the turbojet and sheltering a thrust reverser system (not shown).

The air intake 4 is divided into two portions, namely on one hand, an intake lip 4a adapted to allow optimal uptake towards the turbojet of air necessary to supply the fan and the internal compressors of the turbojet, and on the other hand, a downstream structure 4b on which the lip 4a is mounted and designed to conveniently channel the air towards the blades of the fan. The system is attached upstream of a fan casing belonging to the central section 5 of the nacelle 1.

As shown in FIGS. 1 and 2, the air intake 4 lip 4a is made by using structures 7 mounted onto the downstream structure 4b over the entire periphery of the nacelle 1.

The air intake 4 lip 4a is made here from four structures 7. It could obviously be made by using two structures 7, in a single piece or even from more than four structures 7.

Each structure 7 includes a wall 10 formed in such a way as to give the lip 4a the desired profile and an electric de-icing device 11. The wall 10 may be metallic or made of composite material.

The electric de-icing device 11 is located in contact with an area of the wall 10 facing the inlet of the fan and provided with a multitude of regularly spaced perforations 12.

As shown in FIGS. 2 to 7, the de-icing device 11 includes a panel, including a honeycomb-type cellular structure 13, made of electrically conductive material, such as carbon, and electrical connection means 14 connected to the cellular structure 13.

The cellular structure 13 is substantially flat and the cells 15 thereof extend substantially perpendicularly with respect to the panel. The cellular structure 13 forms a sound attenuation structure.

The cellular structure 13 is made from a system of adjacent strips 16 extending in a general common direction, two adjacent strips 16 being alternately in contact with each other and away from each other to form cells 15.

According to a first embodiment of the invention shown in FIG. 4, the strips 16 are fixed to each other using adhesive layers arranged in the contact areas 17 among the latter, the glue preferably being electrically insulating. In this case, each strip 16 forms a resistance, and the system of adjacent strips 15 forms a system of resistances arranged in parallel.

According to a second embodiment of the invention shown in FIG. 5, the strips 16 are fixed to each other by welding at the contact areas 17 among the latter. In this case, the system of adjacent strips 16 forms a system of resistances arranged in parallel series.

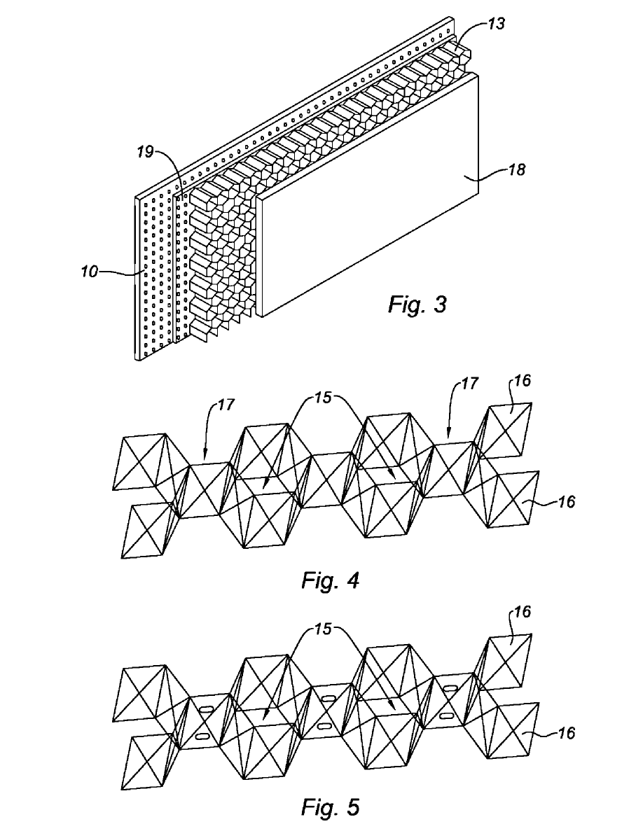

As shown more specifically in FIGS. 2 and 3, the de-icing device panel includes electrically insulating first and second sheets 18, 19 covering the cellular structure so as to seal the cells 15 of the cellular structure 13. The first and second sheets are preferably fibreglass sheets.

The second sheet 19, designed to come into contact with the wall 10 of the structure 7, is provided with a multitude of spaced regularly perforations 20.

It must be observed that the thickness of the first sheet 18 is greater than that of the second sheet 19. Consequently, the first sheet 18 forms a thermal insulation promoting the transfer of heat supplied by the cellular structure 13 towards the wall 10.

The de-icing device 11 is to be connected to an outlet (not shown) of the downstream structure 4b through a connector (not shown) connected by a power cable to conductive strips 21, 22 in contact with the cellular structure.

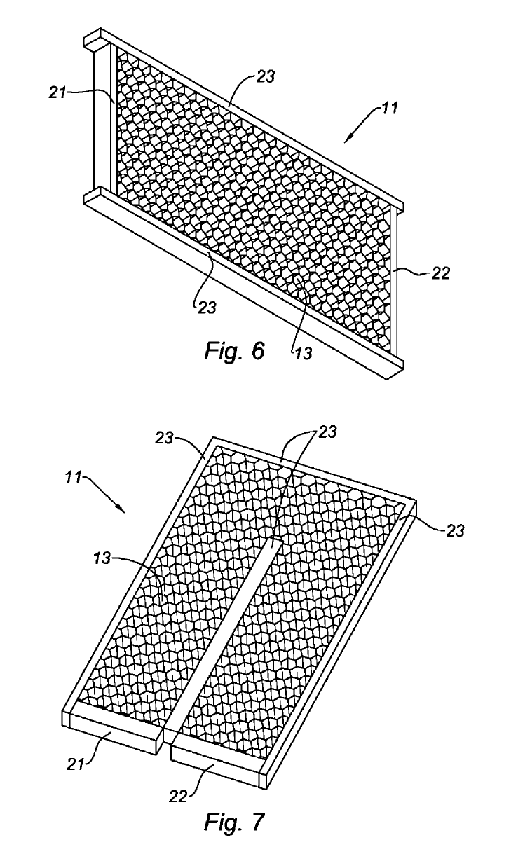

According to a first embodiment of the cellular structure 13 shown in FIG. 6, the cellular structure 13 is rectangular, and the transverse edges thereof are in contact with the first and the second conductive strips 21, 22. In this case, electrically insulating elements 23 cover the lateral edges of the cellular structure 13.

According to a second embodiment of the cellular structure 13 shown in FIG. 7, the cellular structure is substantially U-shaped, and the first and the second conductive strips 21, 22 are in contact with the free ends of the legs of the U. In this case, electrically insulating elements 23 cover the edges of the cellular structure 13. It must be observed that an electrically insulating element 23 is also arranged between the legs of the U so as to electrically isolate the latter.

It goes without saying that the invention is non-exhaustive with respect to the only embodiment of this lip described above by way of an example; it encompasses, on the contrary, all embodiments and applications meeting the same principle.

1. An air intake lip for turbojet nacelle, comprising on an inner surface thereof, an electric de-icing device comprising at least one panel including a cellular structure made of electrically conductive material and an electrical connection means connected to the cellular structure.

2. The lip according to claim 1, wherein cells of the cellular structure extend substantially perpendicularly to a plane of the panel.

3. The lip according to claim 1, wherein the cellular structure is made from a system of adjacent strips extending in a general common direction, two adjacent strips being alternately in contact with each other and away from each other to form cells.

4. The lip according to claim 3, wherein the panel comprises first and second electrical connection means, the first end of each strip being connected to the first electrical connection means and the second end of each strip being connected to the second electrical connection means.

5. The lip according to claim 3, wherein the strips are fixed to each other by using adhesive layers arranged in contact areas among the latter.

6. The lip according to claim 5, wherein the adhesive for gluing the strips to each other is electrically insulating.

7. The lip according to claim 3, wherein the strips are fixed to each other by welding at contact areas between them.

8. The lip according to claim 1, wherein the panel includes first and second electrically insulating sheets covering the cellular structure so to seal the cells of the cellular structure.

9. The lip according to claim 1, wherein the panel includes electrically insulating elements covering edges of the cellular structure.
